(19) United States
(12) Patent Application Publication
(10) Pub. No.: US 2020/0198307 A1
(43) Pub. Date: Jun. 25, 2020

(54) LAMINATED MEMBER

(71) Applicant: FUJI XEROX CO., LTD., Tokyo (JP)

(72) Inventors: Takako Kobayashi, Minamiashigara-shi (JP); Hisae Yoshizawa, Minamiashigara-shi (JP); Fumiaki Mera, Minamiashigara-shi (JP)

(73) Assignee: FUJI XEROX CO., LTD., Tokyo (JP)

(21) Appl. No.: 16/372,860

(22) Filed: Apr. 2, 2019

(30) Foreign Application Priority Data
Dec. 19, 2018 (JP) 2018-237576

(51) Int. Cl. B32B 27/08; B32B 27/30; B32B 27/36; B32B 27/40

(52) U.S. Cl. CPC B32B 27/08; B32B 27/308; B32B 27/365; B32B 2307/538; B32B 2307/412; B32B 2307/536; B32B 27/40

(57) ABSTRACT

A laminated member includes a transparent support substrate containing a resin, and a surface resin layer on the transparent support substrate, in which the surface resin layer contains a cured product of a resin composition containing: an acrylic resin having a hydroxy value of 40 mgKOH/g to 280 mgKOH/g, a polyol having plural hydroxy groups and having a carbon chain having 6 or more carbon atoms in a straight chain linking the hydroxyl groups, and a polyfunctional isocyanate, and in which a ratio [(F_{I}/F_{S})×100 (%)] of a fluorine atom content [F_{I}] on a surface of the surface resin layer after etching a range of 2 mm square on an outermost surface of the surface resin layer with an argon gas cluster ion gun of 5 kV for 20 minutes to a fluorine atom content [F_{S}] on the outermost surface of the surface resin layer ranges from 2% to 50%.

### CROSS-REFERENCE TO RELATED APPLICATIONS

This application is based on and claims a priority under 35 USC 119 from Japanese Patent Application No. 2018-237576 filed on Dec. 19, 2018.

### BACKGROUND

### Technical Field

The present invention relates to a laminated member.

### Related Art

Conventionally, in various fields, from the viewpoint of suppressing scratches on a surface, a surface protective resin member such as a surface protective film is provided. In recent years, a resin layer such as an urethane resin is often used as a member for protecting the surface for scratch resistance.

For example, Japanese Patent No. 5870480 discloses a resin material for use in a member for an image forming device, which is formed by polymerizing an acrylic resin which has a content ratio (molar ratio) of a side chain hydroxy group having 10 or more carbon atoms to a side chain hydroxy group having less than 10 of carbon atoms of less than ⅓ (including a case where the side chain hydroxy group having 10 or more carbon atoms is not contained), a polyol which has a plurality of hydroxy groups and all the hydroxy groups of which are bonded by a chain having 6 or more carbon atoms, and an isocyanate at a polymerization ratio where a ratio (B/A) of a total molar amount (A) to a total molar amount (B) is 0.1 to 10, the total molar amount (A) being the molar amount of hydroxy groups contained in all the acrylic resins used for polymerization, and the total molar amount (B) being the molar amount of hydroxy groups contained in all the polyols used for polymerization.

JP-A-2003-311909 discloses a modified plastic sheet provided with a resin layer containing particles on at least one side of a synthetic resin substrate, in which the resin layer is formed from a polyol resin and a block polyisocyanate as a binder resin.

JP-A-2012-031262 discloses a skin material made of thermoplastic polyolefin resin including a thermoplastic polyolefin resin sheet and a top coat layer formed on the sheet directly or via a primer layer, in which the top coat layer is formed of a resin composition containing, as a main component, a self-crosslinking polyhydroxy polyurethane resin containing a masked isocyanate group in a molecule.

JP-A-2013-078847 discloses a decorative sheet including at least a decorative layer, a primer layer, and a surface protective layer laminated on a substrate made of a polyolefin resin, in the surface protective layer (1) an ionizing radiation curable resin is crosslinked and cured by blending an urethane acrylate (A) having a long chain alkyl group having 13 to 25 carbon atoms and an ionizing radiation curable functional group and being modified with polycaprolactone, and an urethane acrylate (B) obtained by reacting an organic isocyanate having two or more isocyanate groups in one molecule with a hydroxy-modified (meth) acrylate and polycaprolactone-containing polyfunctional alcohol at a blending mass ratio of the urethane acrylate (A) and the urethane acrylate (B) from 25:75 to 75:25,(2) a coating film thickness is 10 μm to 50 μm, (3) after the coating film of the ionizing radiation curable resin of (1) is coated and cured such that the ionizing radiation curable resin on a polypropylene film having a thickness of 140 μm has a thickness of 15 μm, a tensile test is carried out at a temperature of 25° C. and a pulling rate of 50 mm/min, tensile elongation measured by the tensile test to measure elongation at break is 50 to 90%.

JP-A-2013-244650 discloses a laminated film, in which A layer is provided on at least one side of a substrate film and a mass increase rate of the layer A when an oleic acid is applied to a surface of the layer A and then held at 60° C. for 1 hour is 10% by mass or less; a maximum displacement amount in the thickness direction of the layer A is 1.0 μm to 3.0 μm and a creep displacement amount in the thickness direction of the layer A is 0.05 μm to 0.5 μm when the 0.5 mN load is applied for 10 seconds in the microhardness measurement, and a residual displacement amount in the thickness direction of the layer A when the load is 0 mN is 0.2 μm to 0.65 μm.

WO 2014/109177 discloses a laminated film which has a surface layer on at least one surface of a support substrate, in which in the surface layer, 1. 60° specular glossiness specified by JIS Z 8741: 1997 is 60% or more, 2. a retreat contact angle θr of oleic acid is 50° or more, 3. the maximum displacement amount in the thickness direction of the surface layer is 1.0 μm to 3.0 μm and the creep displacement amount in the thickness direction of the surface layer is 0.05 μm to 0.5 μm when the 0.5 mN load is applied for 10 seconds in the microhardness measurement, and the permanent displacement amount in the thickness direction of the surface layer is 0.2 μm to 0.7 μm when the load is released to 0 mN.

### SUMMARY

For example, an urethane resin layer containing a fluorine atom as the surface layer may be used as the member provided on the surface of the object for the purpose of surface protection from the viewpoint of antifouling property or the like, but in the case of containing a fluorine atom, adhesion to the substrate may be poor.

Meanwhile, in a member or the like for surface protection provided on a screen, high visibility (a degree in which the object of surface protection is visually recognized through the member), that is, a transparency of visible light is required. In addition, regarding the visibility, it is also required to suppress decreasing of the visibility itself due to an occurrence of a scratch.

Aspects of certain non-limiting embodiments of the present disclosure relate to a laminated member including a transparent support substrate containing a resin and a surface resin layer disposed so as to contact the transparent support substrate which has high adhesion between the transparent support substrate and the surface resin layer and excellent visibility as compared with a case where the surface resin layer does not contain a cured product of a resin composition containing an acrylic resin containing a fluorine atom having a hydroxyl value of 40 mgKOH/g to 280 mgKOH/g, a polyol having a plurality of hydroxy groups and having a carbon chain of 6 or more carbon atoms, and a polyfunctional isocyanate, or a case where a ratio [F_{I}/F_{S}×100 (%)] of a fluorine atom content [F_{I}] on a surface after etching a range of 2 mm square on an outermost surface with an argon gas cluster ion gun of 5 kV for 20 minutes to a fluorine atom content [F_{S}] on an outermost surface is more than 50% in the surface resin layer.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a laminated member including:

a transparent support substrate containing a resin, and

a surface resin layer on the transparent support substrate,

in which the surface resin layer contains a cured product of a resin composition containing:

an acrylic resin having a hydroxyl value of 40 mgKOH/g to 280 mgKOH/g,

a polyol having a plurality of hydroxyl groups and having a carbon chain having 6 or more carbon atoms in a straight chain portion linking the hydroxyl groups, and

a polyfunctional isocyanate,

in which a ratio [(F_{I}/F_{S})×100(%)] of a fluorine atom content [F_{I}] on a surface of the surface resin layer after etching a range of 2 mm square on an outermost surface with an argon gas cluster ion gun of 5 kV for 20 minutes to the fluorine atom content [F_{S}] on the outermost surface of the surface resin layer ranges from 2% to 50%.

### DETAILED DESCRIPTION

Hereinafter, exemplary embodiments of the present invention are described. The exemplary embodiment is one example of implementing the present invention, and the present invention is not limited to the following exemplary embodiments.

### Laminated Member

The laminated member according to the exemplary embodiment includes a transparent support substrate (hereinafter also simply referred to as “substrate”) containing a resin and a surface resin layer (hereinafter simply referred to as “surface layer”) disposed so as to contact the transparent support substrate.

The surface resin layer contains a polyacrylic urethane resin which is a polymer of a resin composition containing an acrylic resin containing a fluorine atom having a hydroxyl value of 40 mgKOH/g to 280 mgKOH/g (hereinafter simply referred to as “specific acrylic resin”) and a polyol having a plurality of hydroxy groups which are bonded via a carbon chain having 6 or more carbon atoms (hereinafter simply referred to as “long-chain polyol”): and a multifunctional isocyanate.

In the surface resin layer, the ratio [F_{I}/F_{S}×100 (%)] of the fluorine atom content [F_{I}] on the surface after etching the range of 2 mm square on the outermost surface with an argon gas cluster ion gun of 5 kV for 20 minutes to the fluorine atom content [F_{S}] on the outermost surface is 2% to 50%.

When the laminated member according to the exemplary embodiment satisfies the above configuration, high adhesion between the transparent support substrate and the surface resin layer and excellent visibility may be obtained.

The reasons for this are presumed as follows.

First, the surface layer in the exemplary embodiment contains a polyacrylic urethane resin which is a polymer of a resin composition containing a specific acrylic resin (a), a long-chain polyol (b), and a polyfunctional isocyanate (c). The polymer contains a urethane bond (—NHCOO—) formed by reacting the OH group in the specific acrylic resin (a) and the OH group in the long-chain polyol (h) with the isocyanate group in the polyfunctional isocyanate (c). That is, the specific acrylic resin (a) forms a crosslinked structure via the long-chain polyol (b) and the polyfunctional isocyanate (c). The polyacrylic urethane resin having the structure has high transparency.

When the hydroxyl value of the specific acrylic resin (a) is 40 mgKOH/g to 280 mgKOH/g, the crosslinked structure is formed with high harmony property. As a result, it is considered that self-repairing property is imparted to the surface layer. The self-repairing property means that even if scratches occur on the surface due to contact with (for example, rubbing) another substance or the like, the scratch is repaired and restored to the original state or a state close to the original state. That is, in the surface layer, even if in a case where scratches occur, the scratches are restored, so that a decrease in transparency due to the occurrence of scratches on the surface is suppressed.

As described above, since the surface layer in the exemplary embodiment has high transparency and the decrease in transparency due to scratches is suppressed, excellent visibility may be obtained.

Further, in the surface layer according to the exemplary embodiment, the ratio [F_{I}/F_{S}×100 (%)] is 2% or more and 50% or less, that is, fluorine atoms are present at a high density on the outermost surface side of the surface layer, on the other hand, fluorine atoms are low density inside the surface layer. Accordingly, the influence of fluorine atoms at the interface with the substrate is suppressed, and the adhesion between the surface layer and the substrate is enhanced.

Furthermore, in the surface layer in the exemplary embodiment, fluorine atoms are present at a high density on the outermost surface side as described above, so that the surface energy is reduced, thereby improving the antifouling property.

### Ratio of Fluorine Atom Content

In the exemplary embodiment, in the surface layer, the ratio [F_{I}/F_{S}×100 (%)] of the fluorine atom content [F_{I}] on the surface after etching the range of 2 mm square on the outermost surface with an argon gas cluster ion gun of 5 kV for 20 minutes to the fluorine atom content [F_{S}] on the outermost surface is 2% to 50%.

When the ratio [F_{I}/F_{S}×100 (%)] is more than 50%, high adhesion to the substrate may not be obtained. Meanwhile, when the ratio is less than 2%, the content of fluorine on the outermost surface is small and high antifouling property may not be obtained.

The ratio [F_{I}/F_{S}×100 (%)] is preferably 10% to 40%, more preferably 12% to 35%.

From the viewpoint of obtaining high adhesion and high antifouling property, in the surface layer, the ratio [F_{I-2}/F_{S}×100 (%)] of the fluorine atom content [F_{S}] on the outermost surface and the fluorine atom content [F_{I-2}] on the surface after etching the range of 2 mm square on the outermost surface with an argon gas cluster ion gun of 5 kV for 1 minute is preferably 2% to 50%. In addition, the ratio is more preferably 10% to 40%, and even more preferably 12% to 35%.

Similarly, from the viewpoint of obtaining high adhesion and high antifouling property, in the surface layer, the ratio [F_{I-3}/F_{S}×100 (%)] of the fluorine atom content [F_{S}] on the outermost surface and the fluorine atom content [F_{I-3}] on the surface after etching the range of 2 mm square on the outermost surface with an argon gas cluster ion gun of 5 kV for 5 minutes is preferably 2% to 50%. In addition, the ratio is more preferably 10% to 40%, and even more preferably 12% to 35%.

Here, a method of measuring the fluorine atom content will be described.

The fluorine atomic content is measured by XPS (X-ray photoelectron spectroscopy). Specifically, the fluorine atom content is measured by XPS analyzer under the following conditions using an XPS analyzer (model: PHI 5000 Versa Probe II) manufactured by ULVAC-PHI, Inc.

### Measurement Conditions

X-ray source: monochromated Al Ka

Output: 25 W, 15 kV

Detection area: 100 μmφ

Incident angle: 90 degrees

Extraction angle: 45 degrees

Charge Neutralization: neutralization gun condition 1.0 V/ion gun 10 V

The etching method for the surface layer will be described.

Specifically, a range of 2 mm square on the outermost surface of the surface layer is etched with an argon gas cluster ion gun with an output of 5 kV.

### Etching Conditions

Etching gun: argon gas cluster ion gun

Acceleration voltage: 5 kV

Sweeping region: 2 mm×2 mm

Rate: 5 nm/min (in terms of polyester)

From the viewpoint of obtaining high adhesion and high antifouling property, in the surface layer, the ratio [F_{B}/F_{S}×100 (%)] of the fluorine atom content [F_{S}] on the outermost surface and the fluorine atom content [F_{B}] on the interface with the substrate is preferably 1% to 40%. In addition, the ratio is more preferably 1% to 35%, and even more preferably 2% to 35%.

Here, a method of measuring the fluorine atom content [F_{B}] on the interface with the substrate of the surface layer will be described. The fluorine atom content [F_{B}] on the interface is measured by preparing a section having an inclination and measuring the cross section thereof.

First, a section having an inclination of an angle θ is prepared from a laminated member having a substrate and a surface layer by using a microtome. Note that a method described in JP-A-2004-219261 may be used for preparing the section. At the inclination in the section, the fluorine atom content on the interface between the substrate and the surface layer is measured by the method described above. Here, θ is an angle between 0.5° and 2°.

### Achievement Method of the Ratio of Fluorine Atomic Content

Next, a method of controlling the ratio [F_{I}/F_{S}×100 (%)] within the above range will be described. The ratio [F_{I-2}/F_{S}×100 (%)], the ratio [F_{I-3}/F_{S}×100 (%)] and the ratio [F_{B}/F_{S}×100 (%)] may also be controlled by the following method.

The above-mentioned achieving method is not particularly limited, and, for example, the following method may be mentioned.

### Achieving Method (1)

The polyacrylic urethane resin configuring the surface layer is a polymer of a specific acrylic resin (a) having a fluorine atom, a long-chain polyol (b) and a polyfunctional isocyanate (c). Since the fluorine atom has low compatibility with the long-chain polyol (b) and the polyfunctional isocyanate (c), the specific acrylic resin (a) having a fluorine atom tends to be oriented to the outermost surface side of the surface layer, and the long-chain polyol (b) and the polyfunctional isocyanate (c) tend to be oriented to the interface side with the substrate. As a result, it is considered that the ratio [F_{I}/F_{S}×100 (%)] is easily controlled within the above range.

### Achieving Method (2)

From the viewpoint of controlling the ratio [F_{I}/F_{S}×100 (%)] within the above range, the SP value (solubility parameter) of the resin contained in the substrate is preferably 8.1 or more. The reason why the ratio [F_{I}/F_{S}×100 (%)] is easily controlled within the above range when the SP value of the resin in the substrate is 8.1 or more is presumed as follows.

The higher the SP value of the resin, the larger the polar component in the molecular structure of the resin. Due to the presence of the polar component, it is considered that the long-chain polyol (b) and the polyfunctional isocyanate (c) are easily oriented to the interface side with the substrate, and the specific acrylic resin (a) having a fluorine atom is easily oriented to the outermost surface side of the surface layer.

When the polar component is present in the substrate, it is considered that the adhesion between the surface layer and the substrate is further improved by bonding with a functional group such as a hydroxy group of the polyacrylic urethane resin.

From the above viewpoint, an SP value (solubility parameter) of the resin contained in the substrate is preferably 8.1 or more, more preferably 8.15 or more, and further preferably 8.2 or more. On the other hand, from the viewpoint of the stability of the substrate, the upper limit value of the SP value is preferably 20 or less, more preferably 18 or less, further preferably 16 or less.

Examples of the resin having an SP value of 8.1 or more, that is, a resin containing a large number of polar components in the molecular structure include a polyester resin, a polycarbonate resin, and a polyacrylate resin. By including at least one of these resins in the substrate, it is considered that the long-chain polyol (b) and the polyfunctional isocyanate (c) in the surface layer tend to be oriented to the interface with the substrate.

Here, a method of calculating the SP value of the resin will be described.

The monomer composition of the resin is analyzed by a known method and calculated by the Fedor method (specifically, the method described in Polym. Eng. Sci., 14[2](1974)) using the following formula.

SP value=(ΣΔei/ΣΔvi)^{1/2}

Δei: evaporation energy of an atom or atomic group

Δvi: molar volume of an atom or atomic group

### Achieving Method (3)

In addition, examples of the achieving methods include a method using an acrylic resin containing a fluorine atom in the side chain in the molecular structure of the resin as the specific acrylic resin (a) containing a fluorine atom.

The fluorine atom present in the side chain of the specific acrylic resin (a) is considered to be capable of moving flexibly even in the surface layer, that is, the side chain portion having a fluorine atom is considered to be exposed on the outermost surface of the surface layer. Therefore, it is considered that it is easy to orient the specific acrylic resin (a) having a fluorine atom to the outermost surface side of the surface layer, and the long-chain polyol (b) and the polyfunctional isocyanate (c) to the interface with the substrate.

Next, each member configuring the laminated member according to the exemplary embodiment will be described in detail.

### Transparent Support Substrate

The laminated member according to the exemplary embodiment has a transparent support substrate containing a resin.

Here, “transparent” in the substrate means that the transmittance is 80% or more. The transmittance of the substrate is preferably 85% or more, more preferably 89% or more, and preferably close to 100%, from the viewpoint of the visibility of the laminated member.

For the transmittance, the total light transmittance (%) is measured using a haze meter (NDH 2000, manufactured by Nippon Denshoku Industries Co., Ltd.) according to JIS K 7361-1: 1997.

The substrate contains a resin. The substrate preferably contains a resin as a main component, specifically, the content of the resin with respect to the total amount of the substrate is preferably 1% or more, more preferably 5% or more, and further preferably 10% or more, and may be 100%.

From the viewpoint of improving the adhesion between the surface layer and the substrate, the resin contained in the substrate preferably has an SP value (solubility parameter) of 8.1 or more.

From the viewpoint of improving the transparency (that is, the transmittance) of the substrate and controlling the SP value within the above range to easily improve the adhesion, examples of the resin contained in the substrate include a polyester resin, a polycarbonate resin, a polyacrylate resin.

In addition, the substrate may contain other components other than the resin. Examples of other components include fillers (inorganic particles, organic particles, or the like), antistatic agents, friction reducing additives, surface modifiers, ultraviolet absorbers, light stabilizers, or the like.

### Physical Properties of Substrate

In terms of an arithmetic mean height Ra defined by JIS B 0601: 1994, the surface roughness of the substrate on the interface with the surface layer is preferably 5 nm to 100 nm, more preferably 10 nm to 50 nm, and further preferably 15 nm to 40 nm.

When the arithmetic mean height Ra of the surface of the substrate is 5 nm or more, the area of the interface with the surface layer increases, so that the adhesion is enhanced. In the case where the substrate contains a resin having a polar component (for example, containing a resin having an SP value of 8.1 or more, containing at least one resin selected from the group consisting of a polyester resin, a polycarbonate resin, and a polyacrylate resin, or the like), the area of the interface with the surface layer is increased, so that bonds are more strongly formed so as to easily obtain high adhesion.

The arithmetic mean height Ra is measured by a surface roughness tester (SURFCOM 1400A, manufactured by Tokyo Seimitsu Co., Ltd.) according to the provisions of JIS B 0601: 1994.

The thickness (mean thickness) of the substrate is not particularly limited, but is preferably, for example, from 30 μm to 5000 μm, more preferably from 50 μm to 2000 μm, and further preferably from 75 μm to 1000 μm from the viewpoint of the strength of the laminated member.

The mean thickness of the substrate is the arithmetic mean of the thickness at 10 places randomly selected for the substrate.

### Surface Resin Layer

The laminated member according to the exemplary embodiment has a surface resin layer (surface layer) disposed so as to contact the substrate. The surface resin layer may be disposed so as to directly contact the substrate.

The surface layer preferably contains a polyacrylic urethane resin as a main component, specifically, the content of the polyacrylic urethane resin with respect to the total amount of the surface layer is preferably 20% or more, more preferably 30% or more, and further preferably 50% or more, and may be 100%.

The polyacrylic urethane resin contained in the surface layer according to the exemplary embodiment is formed by polymerizing a resin composition containing at least a specific acrylic resin (a), a long-chain polyol (b), and a polyfunctional isocyanate (c).

### (a) Specific Acrylic Resin

In the exemplary embodiment, a specific acrylic resin having a hydroxy group is used as the acrylic resin. The specific acrylic resin has a hydroxyl value of 40 mgKOH/g to 280 mgKOH/g.

The specific acrylic resin having a hydroxy group includes those having a carboxy group in addition to those having a hydroxy group in the molecular structure.

The hydroxy group is introduced, for example, by using a monomer having a hydroxy group as a monomer to be a raw material of the specific acrylic resin. Examples of the monomer having a hydroxy group include (1) an ethylenic monomer having a hydroxy group, such as hydroxymethyl (meth)acrylate, hydroxyethyl (meth)acrylate, hydroxypropyl (meth)acrylate, hydroxy-butyl (meth)acrylate, and N-methylolacrylamine.

In addition, (2) an ethylenic monomer having a carboxy group, such as (meth)acrylic acid, crotonic acid, itaconic acid, fumaric acid, and maleic acid may be used.

Further, a monomer not having a hydroxy group may be used in combination with the monomer to be a raw material of the specific acrylic resin. Examples of the monomer not having a hydroxy group include an ethylenic monomer copolymerizable with the monomers (1) and (2), for example, alkyl (meth)acrylates such as methyl (meth)acrylate, ethyl (meth)acrylate, propyl (meth)acrylate, butyl (meth)acrylate, n-propyl (meth)acrylate, isobutyl (meth)acrylate, 2-ethylhexyl (meth)acrylate, n-octyl (meth)acrylate and n-dodecyl (meth)acrylate.

In the present specification, the term “(meth) acrylic acid” is a concept encompassing both acrylic acid and methacrylic acid.

### Fluorine Atom

The specific acrylic resin contains a fluorine atom in the molecular structure.

The fluorine atom is introduced, for example, by using a monomer having a fluorine atom as a monomer to be a raw material of the specific acrylic resin. Examples of the monomer having a fluorine atom include 2-(perfluorobutyl)ethyl acrylate, 2-(perfluorobutyl)ethyl methacrylate, 2-(perfluorohexyl)ethyl acrylate, 2-(perfluorohexyl)ethyl methacrylate, perfluorohexylethylene, hexafluoropropene, hexafluoropropene epoxide, perfluoro(propyl vinyl ether) or the like.

The fluorine atom is preferably contained in the side chain of the specific acrylic resin. The number of carbon atoms in the side chain containing a fluorine atom is, for example, 2 to 20. In addition, the carbon chain in the side chain containing a fluorine atom may be a linear or branched chain.

The number of fluorine atoms contained in one molecule of the monomer containing a fluorine atom is not particularly limited, and is preferably 1 to 25, and more preferably 3 to 17.

The proportion of the fluorine atom to the whole specific acrylic resin is preferably 0.1% by mass to 50% by mass, and more preferably 1% by mass to 20% by mass.

### Hydroxyl Value

The specific acrylic resin has a hydroxyl value of 40 mgKOH/g to 280 mgKOH/g. The hydroxyl value is more preferably 70 mgKOH/g to 250 mgKOH/g.

Since the hydroxyl value is 40 mgKOH/g or more, a polyacrylic urethane resin having a high crosslinking density is polymerized, penetration of contaminants into the surface layer is suppressed, and excellent antifouling property is obtained. On the other hand, when the hydroxyl value is 280 mg KOH/g or less, a polyacrylic urethane resin having appropriate flexibility is obtained, the viscosity of the solution in which the specific acrylic resin is dissolved is reduced, and the surface layer is excellent in formability.

The hydroxyl value of the specific acrylic resin is adjusted by a proportion of the monomer having a hydroxy group in all the monomers synthesizing the specific acrylic resin, or the like.

The hydroxyl value represents a mg of potassium hydroxide required for acetylating the hydroxy group in 1 g of the sample. The hydroxyl value in the exemplary embodiment is measured according to the method (potentiometric titration method) defined in JIS K 0070: 1992. However, when the sample does not dissolve, a solvent such as dioxane or tetrahydrofuran (THF) is used as a solvent.

The synthesis of the specific acrylic resin is performed, for example, by mixing the above-mentioned monomers, and performing ordinary radical polymerization, ionic polymerization or the like, and followed by purification.

### (b) Long-Chain Polyol

The long-chain polyol is a polyol having a plurality of hydroxy groups (—OH) and having the hydroxy groups bonded via a carbon chain having 6 or more carbon atoms (the number of carbon atoms in the straight chain linking the hydroxy groups). That is, the long-chain polyol is a polyol in which all the hydroxy groups are bonded via a carbon chain having 6 or more carbon atoms (the number of carbon atoms in the straight chain linking the hydroxy groups).

The long-chain polyol may have a functional group number (that is, the number of hydroxy groups contained in one molecule of the long-chain polyol), for example, in a range of 2 to 5, or 2 to 3.

The carbon chain having 6 or more carbon atoms in the long-chain polyol represents a chain whose number of carbon atoms in the straight chain linking the hydroxy groups is 6 or more. Examples of the carbon chain having 6 or more carbon atoms include an alkylene group or a divalent group formed by combining one or more of alkylene groups with one or more groups selected from —O—, —C(═O)—, and —C(═O)—O—. It is preferable that the long-chain polyol having hydroxy groups bonded via a carbon chain having 6 or more carbon atoms has a structure of —[CO(CH₂)ₙ₁O]ₙ₂—H (here, n1 represents 1 to 10 (preferably 3 to 6, and more preferably 5), and n2 represents 1 to 50 (preferably 1 to 35, more preferably 1 to 10, and still more preferably 2 to 6).).

Examples of the long-chain polyol include a bifunctional polycaprolactone diol, a trifunctional polycaprolactone triol, a tetrafunctional or higher functional polycaprolactone polyol or the like.

Examples of the bifunctional polycaprolactone diol include a compound represented by —[CO(CH₂)ₙ₁₁O]ₙ₁₂—H (Here, n11 represents 1 to 10 (preferably 3 to 6, and more preferably 5), and n12 represents 1 to 50 (preferably 3 to 35).) and having two groups having a hydroxy group in the terminal. Among these, the compound represented by the following General Formula (1) is preferred.

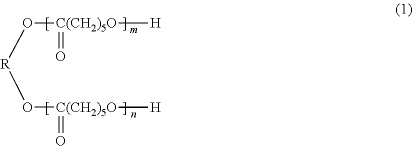

(In General Formula (1), R represents an alkylene group or a divalent group formed by combining an alkylene group and one or more groups selected from —O— and —C(═O)—, and m and n each independently represents an integer of 1 to 35.)

In General Formula (1), the alkylene group contained in the divalent group represented by R may be linear or branched. The alkylene group is, for example, preferably —an alkylene group having 1 to 10 carbon atoms, and more preferably an alkylene group having 1 to 5 carbon atoms.

The divalent group represented by R is preferably a linear or branched alkylene group having 1 to 10 carbon atoms (preferably 2 to 5 carbon atoms), or preferably a group formed by linking two linear or branched alkylene groups having 1 to 5 carbon atoms (preferably 1 to 3 carbon atoms) with —O—or —C(═O)— (preferably —O—). Among these, the divalent groups represented by *—C₂H4—*, *—C₂H₄OC₂H₄—*, or *—C(CH₃)₂—(CH₂)₂—* are more preferred. The divalent groups listed above are bonded at the “*” part, respectively.

m and n each independently represent an integer of 1 to 35, preferably 2 to 10, and more preferably 2 to 5.

Examples of the trifunctional polycaprolactone triol include a compound represented by —[CO(CH₂)ₙ₂₁O]ₙ₂₂—H (Here, n21 represents 1 to 10 (preferably 3 to 6, and more preferably 5), and n22 represents 1 to 50 (preferably 1 to 28).) and having three groups having a hydroxy group in the terminal. Among these, the compound represented by the following General Formula (2) is preferred.

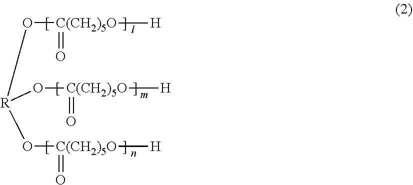

(In General Formula (2), R represents a trivalent group formed by removing one hydrogen atom from an alkylene group, or a trivalent group formed by combining a trivalent group formed by removing one hydrogen atom from an alkylene group and one or more groups selected from an alkylene group, —O—, and —C(═O)—. l, m, and n each independently represent an integer of 1 to 28, and l+m+n is 3 to 30.)

In General Formula (2), in a case where R represents the trivalent group formed by removing one hydrogen atom from an alkylene group, the group may be linear or branched. The trivalent group formed by removing one hydrogen atom from an alkylene group is, for example, preferably an alkylene group having 1 to 10 carbon atoms, and more preferably an alkylene group having 1 to 6 carbon atoms.

The R may be a trivalent group formed by combing the trivalent group formed by removing one hydrogen atom from an alkylene group shown above and one or more groups selected from an alkylene group (for example, an alkylene group having 1 to 10 carbon atoms), —O—, and —C(═O)—.

The trivalent group represented by R is preferably a trivalent group formed by removing one hydrogen atom from a linear or branched alkylene group having 1 to 10 carbon atoms (preferably 3 to 6 carbon atoms). Among these, the trivalent groups represented by *—CH₂—CH(-*)—CH₂—*, CH₃—C(-*)(-*)—(CH₂)₂—*, and CH₃CH₂C(-*)(-*)(CH₂)₃—* are more preferred. The trivalent groups listed above are bonded at the “*” part, respectively.

l, m and n each independently represent an integer of 1 to 28, preferably 2 to 10, and more preferably 2 to 5. l+m+n is 3 to 30, preferably 6 to 30, and more preferably 6 to 20.

The long-chain polyol may be used alone only, or may be used in combination of two or more thereof.

A molar ratio [OH_{A}/OH_{P}] of the total hydroxy group amount [OH_{A}] in the specific acrylic resin (a) to the total hydroxy group amount [OH_{P}] in the long-chain polyol (b) is preferably 0.1 to 4, more preferably 0.15 to 3, and further preferably 0.25 to 2.

When the molar ratio [OH_{A}/OH_{P}] is 0.1 to 4, the harmony property between the amount of the specific acrylic resin (a) as a hard segment and the amount of the long-chain polyol (b) as a soft segment is increased, the self-repairing property of the surface layer is easily enhanced.

The long-chain polyol preferably has a hydroxyl value of 30 mgKOH/g to 300 mgKOH/g, and more preferably 50 mgKOH/g to 250 mgKOH/g. When the hydroxyl value is 30 mgKOH/g or more, a urethane resin having a high crosslinking density is polymerized, and on the other hand, when the hydroxyl value is 300 mgKOH/g or less, a urethane resin having appropriate flexibility is easily obtained.

The above hydroxyl value represents a mg of potassium hydroxide required for acetylating the hydroxy group in 1 g of the sample. The above hydroxyl value in the exemplary embodiment is measured according to the method (potentiometric titration method) defined in JIS K 0070: 1992, However, when the sample does not dissolve, a solvent such as dioxane or THF is used as a solvent.

### (c) Polyfunctional Isocyanate

The polyfunctional isocyanate (c) is a compound having a plurality of isocyanate groups (—NCO), and reacts with, for example, the hydroxy group of the specific acrylic resin (a), the hydroxy group of the long-chain polyol (b), or the like to form a urethane bond (—NHCOO—). In addition, the polyfunctional isocyanate functions as a crosslinking agent for crosslinking specific acrylic resins (a), the specific acrylic resin (a) and the long-chain polyol (b), and long-chain polyols (b).

Examples of the polyfunctional isocyanate are not particularly limited and include a bifunctional diisocyanate such as methylene diisocyanate, toluene diisocyanate, hexamethylene diisocyanate, and isophorone diisocyanate. In addition, a polyfunctional isocyanate which is a multimer of hexamethylene polyisocyanate and has a burette structure, an isocyanurate structure, an adduct structure, an elastic structure, or the like is also preferably used.

Commercially available polyfunctional isocyanate may be used, for example, polyisocyanate (DURANATE) manufactured by Asahi Kasei Corporation.

The polyfunctional isocyanate may be used alone only, or may be used in combination of two or more thereof.

The amount of the polyfunctional isocyanate is adjusted such that the proportion of the isocyanate group (—NCO) is preferably 0.8 to 1.6 in terms of molar ratio, and more preferably from 1 to 1.3 in terms of molar ratio, with respect to the total amount of the hydroxy groups (—OH) in the specific acrylic resin (a) and the long-chain polyol (b).

When the amount of the polyfunctional isocyanate is 0.8 or more in terms of molar ratio, an urethane resin having a high crosslinking density is polymerized and the self-repairing property of the surface layer to be formed is easily enhanced. On the other hand, when the amount of the polyfunctional isocyanate is 1.6 or less in terms of molar ratio, an urethane resin having appropriate elasticity is easily obtained.

### Other Additives

The surface layer according to the exemplary embodiment may further contain other additives. For example, examples of the other additives include an antistatic agent, a reaction accelerator for accelerating the reaction between the hydroxy group (—OH) in the specific acrylic resin (a) and the long-chain polyol (b) and the isocyanate group (—NCO) in the polyfunctional isocyanate (c), or the like.

### Antistatic Agent

Specific examples of the antistatic agent include cationic surface active compounds (e.g., a tetraalkylammonium salt, a trialkybenzylammonium salt, an alkylamine hydrochloride, and an imidazolium salt), anionic surface active compounds (e.g., an alkyl sulfonate, an alkyl benzene sulfonate, and an alkyl phosphate), nonionic surface active compounds (e.g., glycerin fatty acid ester, polyoxyalkylene ether, polyoxyethylene alkyl phenyl ether, N,N-bis-2-hydroxyethylalkylamine, hydroxyalkyl monoethanolamine, polyoxyethylene alkylamine, fatty acid diethanolamide, and polyoxyethylene alkylamine fatty acid ester), amphoteric surface active compounds (e.g., alkyl betaine and alkyl imidazolium betaine), or the like.

In addition, examples of the antistatic agent include those containing quaternary ammonium.

Specifically, examples of the antistatic agent include tri-n-butylmethylammonium bistrifluoromethanesulfonimide, lauryl trimethyl ammonium chloride, octyldimethyl ethyl ammonium ethyl sulphate, didecyl dimethyl ammonium chloride, lauryl dimethyl benzyl ammonium chloride, stearyl dimethyl hydroxyethyl ammonium para-toluene sulfonate, tributylbenzylammonium chloride, lauryldimethylaminoacetic acid betaine, lauric acid amidopropyl betaine, octanoic acid amidopropyl betaine, polyoxyethylene stearylamine hydrochloride, or the like. Among these, tri-n-butylmethylammonium bistrifluoromethanesulfonimide is preferred.

In addition, an antistatic agent having a high molecular weight may be used.

Examples of the antistatic agent having a high molecular weight include a polymer compound obtained by polymerizing a quaternary ammonium salt group-containing acrylate, a polymer compound based on polystyrene sulfonic acid, a polymer compound based on polycarboxylic acid, a polyetherester-based polymer compound, a polymer compound based on ethylene oxide-epichlorohydrin, a polyetheresteramide-based polymer compound, or the like.

Examples of the polymer compound obtained by polymerizing a quaternary ammonium salt group-containing acrylate include a polymer compound having at least the following structural unit (A).

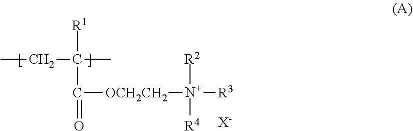

(In structural unit (A), R¹ represents a hydrogen atom or a methyl group, R², R³ and R⁴ each independently represents an alkyl group, and X⁻ represents an anion.)

The polymerization of the antistatic agent having a high molecular weight may be performed by a known method.

As the antistatic agent having a high molecular weight, only a polymer compound composed of the same polymerizable monomers may be used, or two or more of polymer compounds composed of different polymerizable monomers may be used in combination.

It is preferable to adjust the surface resistance of the surface layer formed in the exemplary embodiment to be in the range of 1×10⁹Ω/cm to 1×10¹⁴Ω/cm, and to adjust the volume resistance thereof to be in the range of 1×10⁸Ωcm to 1×10¹³Ωcm.

The surface resistance and the volume resistance are measured in accordance with JIS-K6911 under the environment of 22° C. and 55% RH using a HIRESTA UP MCP-450 UR probe manufactured by Dia Instruments Co., Ltd.

The surface resistance and the volume resistance of the surface layer are controlled by adjusting the type, content, or the like of the antistatic agent as long as the antistatic agent is contained.

The antistatic agent may be used alone, or may be used in combination of two or more thereof.

### Reaction Accelerator

Examples of the reaction accelerator for accelerating the reaction between the hydroxy group (—OH) in the specific acrylic resin (a) and the long-chain polyol (b) and the isocyanate group (—NCO) in the polyfunctional isocyanate (c) include a metal catalyst of tin or bismuth. For examples, Neostann U-28, U-50, U-600 and tin stearate (II) manufactured by NITTO KASEI Co., Ltd., may be used. In addition, XC-C277 and XK-640 manufactured by Kusumoto Chemicals, Ltd. may be used.

### Formation of Surface Resin Layer

The method for forming the surface layer in the laminated member is not particularly limited. For example, the surface layer may be formed by polymerizing and curing a resin composition for forming a surface layer containing a specific acrylic resin (a), a long-chain polyol (b), and a polyfunctional isocyanate (c).

As an example of the method for forming the surface layer, a solution set for forming the surface layer contains a first solution containing a specific acrylic resin (a) and a long-chain polyol (b), and a second solution containing a polyfunctional isocyanate (c). The first solution and the second solution are mixed and coated onto the substrate to form a coating film. Next, the surface layer may be formed by heating and curing.

### Physical Properties of the Surface Layer

### Thickness

The thickness (mean thickness) of the surface layer is not particularly limited, but is preferably 10 μm to 100 μm, more preferably 12.5 μm to 80 μm, and further more preferably 15 μm to 75 μm.

When the thickness of the surface layer is 10 μm or more, the difference in height due to the roughness on the surface of the substrate is sufficiently filled by the surface layer, and the smoothness of the surface (that is, the outermost surface on the surface layer side) of the laminated member may be improved, and the transparency thereof may be enhanced. On the other hand, when the thickness of the surface layer is 100 μm or less, the surface layer is excellent in formability.

A ratio of the thickness of the transparent support substrate to the thickness of the surface resin layer ranges preferably from 100:1 to 7:1, more preferably from 10:1 to 7:1.

### Martens Hardness

The surface layer preferably has a Martens hardness at 23° C. of 0.5 N/mm² to 220 N/mm², more preferably 1 N/mm² to 150 N/mm², still more preferably 1 N/mm² to 80 N/mm², and even more preferably 1 N/mm² to 60 N/mm².

When the Martens hardness (23° C.) is 0.5 N/mm² or more, the shape required for the surface layer may be easily maintained. On the other hand, when the Martens hardness (23° C.) is 220 N/mm² or less, the ease of repairing a scratch (that is, self-repairing property) is easily improved.

### Return Rate

The surface layer preferably has a return rate at 23° C. of 70% to 100%, more preferably 80% to 100%, and even more preferably 90% to 100%.

The return rate is an index indicating the self-repairing property of the resin material (the property of restoring the strain generated by the stress within 1 minute after unloading the stress, that is, the degree of repairing a scratch). That is, when the return rate (23° C.) is 70% or more, the ease of repairing a scratch (that is, self-repairing property) is improved.

The Martens hardness and the return rate of the surface layer are adjusted, for example, by controlling the hydroxyl value of the specific acrylic resin (a), the number of carbon atoms in the chain linking the hydroxy groups in the long-chain polyol (b), the ratio of the long-chain polyol (b) with respect to the specific acrylic resin (a), the number of functional groups (isocyanate groups) in the polyfunctional isocyanate (c), and the ratio of the polyfunctional isocyanate (c) with respect to the specific acrylic resin (a).

The Martens hardness and the return rate is measured by using FISCHER SCOPE HM 2000 (manufactured by Fischer Instruments Co., Ltd.) as a measuring device, fixing a surface layer (sample) to a slide glass with an adhesive and setting to the above measuring device. The surface layer is loaded with 0.5 mN at a specific measurement temperature (that is, 23° C.) for 15 seconds, and held at 0.5 mN for 5 seconds. The maximum displacement at this time is set to be (h1). Thereafter, the load is reduced to 0.005 mM for 15 seconds, and the surface layer is held at 0.005 mN for 1 minute. The displacement at this time is set to be (h2), and the return rate [(h1−h2)/h1]×100 (%) is calculated. From the load displacement curve at this measurement, the Martens hardness may be obtained.

### Self-Repairing Property

As an index of the self-repairing property of the surface layer, the repairing time of scratches at 25° C. is preferably 0.1 second to 72 hours when scratches are made by a metal brush at a speed of 30 cm/min and a width of 3 cm for reciprocating 50 times at a load of 250 g/cm² on the outermost surface. Furthermore, the repairing time is more preferably 0.5 seconds to 48 hours, and further more preferably 1 second to 24 hours.

The repairing of the scratches mentioned here means that scratches are repaired to a state in which the change in haze value is within 2.5% With respect to the surface layer before scratching.

### Transmittance

From the viewpoint of obtaining high visibility, the surface layer preferably has a transmittance of 89% to 99% in a single layer when the thickness (mean thickness) is 50 μm. Furthermore, the transmittance is more preferably 90% to 98%, and further more preferably 91% to 97%.

For the transmittance, the total light transmittance (%) is measured using a haze meter (NDH 2000, manufactured by Nippon Denshoku Industries Co., Ltd.) according to JIS K 7361-1: 1997.

### Change Property of Transmittance Between the Substrate and the Laminated Member

The transmittance of the laminated member according to the exemplary embodiment is preferably 0.5% to 8% higher, more preferably 1% to 6% higher, and further preferably 1% to 5% higher as compared with the transmittance of the substrate.

That is, it is preferable that the laminated member having the surface layer on the substrate has higher transmittance than the substrate without the surface layer. Accordingly, high visibility is easily obtained.

Incidentally, the reason why the transmittance increases due to the formation of the surface layer is presumed as follows. Generally, when a laminated member is prepared by providing a surface layer on a surface of a substrate, it is considered that an absorption factor absorbing light passing through the laminated member is integrated by the substrate and the surface layer. However, different from this phenomenon, it is possible to efficiently transmit light by forming a layer having high smoothness and high gloss as a surface layer, and as a result, it is considered that the transmittance of the laminated member may be higher than that of the substrate itself.

### Adhesive Layer

The laminated member may have other layers other than the substrate and the surface layer. For example, the laminated member may have an adhesive layer disposed on a surface at the side of the substrate not having the surface layer.

The adhesive layer is, for example, a layer provided for the purpose of attaching the laminated member to the surface of another member. The adhesive layer is not particularly limited as long as the adhesive layer has transparency, and any known adhesive tape, adhesive film or the like may be used.

“Transparent” in the adhesive layer means that the transmittance is 80% or more, similarly to the substrate. The transmittance of the adhesive layer is preferably 85% or more, more preferably 89% or more, and further preferably close to 100% from the viewpoint of the visibility of the laminated member. The transmittance is measured by the same method as the substrate.

### Physical Properties of Laminated Member

### Glossiness

From the viewpoint of facilitating high visibility, the 60° glossiness (gloss) of the surface (that is, the outermost surface on the side having the surface layer) is preferably 130 or more, more preferably 130 to 180, and further preferably 135 to 175.

The glossiness is measured at a measurement angle of 60° by placing a sample on a white paper using a gloss meter (MICRO-TRI GLOSS, manufactured by BYK Gardner).

### Application

The laminated member according to the exemplary embodiment may be used as a surface protective member for an object which may have scratches on the surface due to contact with other substances, and which is required to have visibility, for example.

Specifically, examples thereof include a screen in a portable device (for example, mobile phone, portable game machine, etc.), a screen of a touch panel, lenses of glasses, a mirror, a monitor, a bulletin board, a card, or the like.

### EXAMPLES

Hereinafter, the exemplary embodiments of the present invention are described in more detail with reference to Examples and Comparative Examples, but the exemplary embodiments of the present invention are not limited to the following examples. In the following, “part” is on a mass basis unless otherwise specified particularly.

### Example 1

### Synthesis of Acrylic Resin Prepolymer

Polymerizable monomers of n-butyl methacrylate (nBMA), hydroxyethyl methacrylate (HEMA) and an acrylic monomer containing a fluorine atom (having a perfluorohexyl group, FAMAC 6, manufactured by UNIMATEC CO., LID.) are mixed in a molar ratio of 2.5:3.0:0.5. Further, a polymerizable monomer solution is prepared by adding a polymerization initiator (azobisisobutyronitrile (AIBN)) having a polymerizable monomer ratio of 2% by mass and methyl ethyl ketone (MEK) having a polymerizable monomer ratio of 40% by mass.

The polymerizable monomer solution is charged into a dropping funnel and added dropwise to MEK, having a polymerizable monomer ratio of 50% by mass, heated to 80° C. under a nitrogen reflux over 3 hours while stirring for polymerization. Further, a solution containing MEK having a polymerizable monomer ratio of 10% by mass and AIBN having a polymerizable monomer ratio of 0.5% by mass is added dropwise over 1 hour to complete the reaction. During the reaction, the temperature is kept at 80° C. and stirring is continued. Thus, an acrylic resin prepolymer A1 is synthesized.

The hydroxyl value of the obtained acrylic resin prepolymer A1 is measured according to the method (potentiometric titration method) defined in JIS K 0070-1992, and as a result, the hydroxyl value is 175 mgKOH/g.

In addition, the weight average molecular weight of the acrylic resin prepolymer A1 is measured by the above method using gel permeation chromatography (GPC), and as a result, the weight average molecular weight is 17000.

### Preparation of Surface Layer Forming Solution (Polymer 1)

The following components are mixed and stirred, and then a first solution is prepared.

Acrylic resin prepolymer A1 solution (solid content of 50% by mass): 42 parts

Long-chain polyol (polycaprolactone triol, PLACCEL 308, manufactured by Daicel Corporation, having a molecular weight of 850 and a hydroxyl value of 190 mgKOH/g to 200 mgKOH/g): 38 parts

Methyl ethyl ketone: 20 parts

The ratio (molar ratio [OH_{A}/OH_{P}]) of the total hydroxy group amount of the acrylic resin prepolymer A1 and the total hydroxy group amount of the long-chain polyol is 0.5.

In addition, the following second solution is prepared.

The second solution (polyfunctional isocyanate, DURANATE TPA 100, manufactured by Asahi Kasei Chemicals Corporation, compound name: polyisocyanurate form of hexamethylene diisocyanate): 40 parts

The second solution is added to the first solution and defoamed under reduced pressure for 10 minutes. Further, a reaction catalyst (inorganic bismuth) is added to prepare a surface layer forming solution (polymer 1).

### Formation of Laminated Film (1)

A polyester film (COSMOSHINE (registered trademark), manufactured by Toyobo Co., Ltd., mean thickness: 150 μm) is prepared as a substrate 1.

The surface layer forming solution (polymer 1) is coated on a substrate with a wire bar and cured at 80° C. for 1 hour to form a surface layer. Thus, a laminated film (1) is obtained.

### Example 2

A surface layer forming solution (polymer 2) is prepared in the same manner as in Example 1 except that in preparing the first solution in the preparation of the surface layer forming solution (polymer 1) in Example 1, with respect to the acrylic resin prepolymer A1 solution (solid content of 50% by mass) and the long-chain polyol (polycaprolactone triol, PLACCEL 308, manufactured by Daicel Corporation), the mass ratio of both are changed without changing the total amount such that the ratio (molar ratio [OH_{A}/OH_{P}]) of the total hydroxy group amount of both is 2.0, and further a laminated film (2) is obtained.

### Example 3

A laminated film (3) is obtained in the same manner as in Example 1, except that the acrylic resin prepolymer A1 used in Example 1 is changed to a mixture of the acrylic resin prepolymer A1 and an acrylic resin prepolymer A2 haying no fluorine atom, and further a surface layer forming solution having the following composition (polymer 3) is prepared.

### Synthesis of Acrylic Resin Prepolymer A2

An acrylic resin prepolymer A2 is synthesized in the same manner as the acrylic resin prepolymer A1, except that in the synthesis of the acrylic resin prepolymer A1 of Example 1, the acrylic monomer having a fluorine atom (FAMAC 6, manufactured by UNIMATEC CO., LTD.) is not used, and prepolymers are synthesized by mixing polymerizable monomers of n-butyl methacrylate (nBMA) and hydroxyethyl methacrylate (HEMA) in a molar ratio of 3.4:2.6.

The hydroxyl value of the obtained acrylic resin prepolymer A2 is 175 mgKOH/g. The weight average molecular weight of the acrylic resin prepolymer A1 is 16000.

### Preparation of Surface Layer Forming Solution (Polymer 3)

The following components are mixed and stirred, and then a first solution is prepared.

Acrylic resin prepolymer A1 solution (solid content of 50% by mass): 18 parts

Acrylic resin prepolymer A2 solution (solid content of 50% by mass): 22 parts

Long-chain polyol (polycaprolactone triol, PLACCEL 308, manufactured by Daicel Corporation, having a molecular weight of 850 and a hydroxyl value of 190 mgKOH/g to 200 mgKOH/g): 41 parts

Methyl ethyl ketone: 20 parts

The ratio (molar ratio [OH_{A}/OH_{P}]) of the total hydroxy group amount of the acrylic resin prepolymer A1 to the total hydroxy group amount of the long-chain polyol is 0.4.

### Example 4

A surface layer forming solution (polymer 4) is prepared in the same manner as in Example 1, except that the acrylic resin prepolymer A1 used in Example 1 is changed to the following acrylic resin prepolymer A3, and further a laminated film (4) is obtained.

### Synthesis of Acrylic Resin Prepolymer A3

An acrylic resin prepolymer A3 is synthesized in the same manner as the acrylic resin prepolymer A1, except that in the synthesis of the acrylic resin prepolymer A1 of Example 1, a prepolymer is synthesized by mixing polymerizable monomers of n-butyl methacrylate (nBMA), hydroxyethyl methacrylate (HEMA) and an acrylic monomer containing a fluorine atom (having a perfluorohexyl group, FAMAC 6, manufactured by UNIMATEC CO., LTD.) in a molar ratio of 0.5:5.0:0.5.

The hydroxyl value of the obtained acrylic resin prepolymer A3 is 285 mgKOH/g. The weight average molecular weight of the acrylic resin prepolymer A1 is 20000.

### Example 5

A laminated film (5) is obtained in the same manner as in Example 1, except that the substrate 1 (COSMOSHINE) used in Example 1 is changed to a substrate 2 (polyethylene naphthalate film, Teijin Ltd., TEONEX (registered trademark), product number: Q 51, mean thickness: 150 μm).

### Example 6

A laminated film (6) is obtained in the same manner as in Example 1, except that the substrate 1 (COSMOSHINE) used in Example 1 is changed to a substrate 3 (biaxially oriented polypropylene film, FOTAMURA CHEMICAL CO., LID., FOS, mean thickness: 60 μm).

### Comparative Example 1

In Example 1, a surface layer is not formed on the substrate 1 (COSMOSHINE), that is, a film (7) as the substrate 1 is obtained.

### Comparative Example 2

According to the following method, a surface layer of the surface layer forming solution (polymer 5) is formed on the substrate 1 to obtain a laminated film (8).

The following components are mixed and stirred, and then a first solution is prepared.

Acrylic resin prepolymer A1 solution (solid content of 50% by mass): 80 parts

Methyl ethyl ketone: 20 parts

In addition, the following second solution is prepared.

The second solution (polyfunctional isocyanate, DURANATE TPA 100, manufactured by Asahi Kasei Chemicals Corporation, compound name: polyisocyanurate form of hexamethylene diisocyanate): 40 parts. The second solution is added to the first solution and defoamed under reduced pressure for 10 minutes. Further, a reaction catalyst (inorganic bismuth) is added to prepare the surface layer forming solution (polymer 5).

Using the polyester film (COSMOSHINE (registered trademark), manufactured by Toyobo Co., Ltd., mean thickness: 150 μm) as the substrate 1, the surface layer forming solution (polymer 5) is coated and cured on the substrate in the same manner as in Example 1 to form a surface layer. Thus, the laminated film (8) is obtained.

### Measurement of Physical Properties

The surface roughness Ra (nm) on the interface with the surface layer of the substrate, the Martens hardness (N/mm²) of the surface layer at 23° C., the return rate (%) of the surface layer at 23° C., 60° glossiness (gloss) of the laminated film are measured by the above-mentioned methods, respectively.

Further, the fluorine atom content [F_{S}] on the outermost surface of the surface layer, the fluorine atom content [F_{I}] on the surface after etching the range of 2 mm square on the outermost surface with an argon gas cluster ion gun of 5 kV for 20 minutes, the fluorine atom content [F_{I-2}] on the surface after etching the range of 2 mm square on the outermost surface with an argon gas cluster ion gun of 5 kV for 1 minute, the fluorine atom content [F_{I-3}3] on the surface after etching the range of 2 mm square on the outermost surface with an argon gas cluster ion gun of 5 kV for 5 minutes, and the fluorine atom amount [F_{B}] on the interface with the substrate of the surface layer are measured by the above-mentioned methods, respectively.

Further, the transmittance (%) of the substrate and the transmittance (%) of the laminated film, that is, the state where the surface layer is formed on the substrate, are measured by the above-mentioned methods.

The results are shown in Table 1 and Table 2.

### [Evaluation]—Repairing Time

For the laminated films obtained in Examples and Comparative Examples, scratches are made by a metal brush at a speed of 30 cm/min and a width of 3 cm for reciprocating 50 times at a load of 250 g/cm² on the surface layer, and the repairing time of the scratches in an environment of 25° C. is measured. Note that repairing a scratch means that the scratch is repaired to a state in which the change in haze value is within 2.5% with respect to the surface layer before scratching.

### Adhesion Cross-Cut

The adhesion between the substrate and the surface layer is evaluated on the laminated films obtained in Examples and Comparative Examples by a cross-cut method according to JIS K 5600-5-6: 1999. Evaluation is carried out according to the following evaluation criteria.

### Evaluation Criteria

A: no peeling

B: partial peeling

C: Full peeling

### Visibility

The laminated films are scratched in the same manner as in the test of the repairing time, and left to stand for 24 hours in an environment of 25° C. Then, each laminated film is placed on a mobile phone display, and the visibility of the characters is checked. Evaluation is carried out according to the following evaluation criteria.

### Evaluation Criteria

A: Characters may be clearly recognized

B: Characters is partially unclear, but may be recognized

C: Characters may not be recognized

### Antifouling Property

For the laminated films obtained in Examples and Comparative Examples, the surface layer is painted out with oily marking pen (MCKEE), left to stand for 24 hours, and wiped off with alcohol to check the residue of painted-out by the marking pen. Evaluation is carried out according to the following evaluation criteria.

### Evaluation Criteria

A: No fouling

B: Partly light fouling remaining

C: Heavy fouling remaining

TABLE 1

| | | | | Surface Layer | | | | | |
|---|---|---|---|---|---|---|---|---|---|
| | | | | | Fluorine content (atom %) | | | | |
| | Substrate | | | | [F_{S}] | [F₁] | [F₁₋₂] | [F₁₋₃] | [F_{B}] |
| | | | Surface | | on the | after etching | after etching | after etching | on interface |
| | | SP value | roughness Ra | | outermost | for 20 | for 1 | for 5 | with |
| | Type | of resin | (mm) | Type | surface | minutes | minute | minutes | substrate |
| Example 1 | Substrate 1 | 10.1 | 31 | Polymer 1 | 22 | 3 | 3 | 3 | 4 |
| Example 2 | Substrate 1 | 10.1 | 31 | Polymer 2 | 21 | 5 | 6 | 5 | 6 |
| Example 3 | Substrate 1 | 10.1 | 31 | Polymer 3 | 22 | 2 | 7 | 7 | 7 |
| Example 4 | Substrate 1 | 10.1 | 31 | Polymer 4 | 22 | 3 | 3 | 3 | 4 |
| Example 5 | Substrate 2 | 12.2 | 5 | Polymer 1 | 22 | 3 | 3 | 3 | 4 |
| Example 6 | Substrate 3 | 7.5 | 20 | Polymer 1 | 22 | 3 | 3 | 3 | 4 |
| Comparative | Substrate 1 | 10.1 | 31 | Null | | | | | |
| Example 1 | | | | | | | | | |
| Comparative | Substrate 2 | 10.1 | 31 | Polymer 5 | 15 | 10 | 9 | 10 | 10 |
| Example 2 | | | | | | | | | |

TABLE 2

| | Surface Layer | | | | Physical | Transmittance (%) | | | | | |
|---|---|---|---|---|---|---|---|---|---|---|---|
| | Molar | Mean | Martens | | Properties | | Substrate + | Evaluation | | | |
| | Ratio | Thickness | Hardness | Return | 60° | | Surface | Repairing | Adhesion | Visibil- | Antifouling |
| | [OH_{A}/OH_{P}] | (μm) | (N/mm²) | Rate (%) | Gloss | Substrate | Layer | Time (h) | Cross-cut | ity | Property |
| Example 1 | 0.5 | 32 | 3.5 | 87 | 160 | 88.5 | 91.5 | 0.1 | A | A | A |
| Example 2 | 2.0 | 30 | 80 | 86 | 153 | 88.5 | 91.6 | 8 | A | A | A |
| Example 3 | 0.4 | 28 | 2.9 | 88 | 169 | 88.5 | 92 | 0.1 | A | A | A |
| Example 4 | 0.5 | 30 | 3.5 | 87 | 160 | 88.5 | 91.2 | 0.2 | A | B | A |
| Example 5 | 0.5 | 30 | 3.5 | 87 | 160 | 90 | 91.5 | 0.1 | B | A | A |
| Example 6 | 0.5 | 31 | 3.5 | 87 | 160 | 87 | 86 | 0.1 | C | B | B |
| Comparative | Null | | | | — | 88.5 | — | No | — | C | C |
| Example 1 | | | | | | | | repairing | | | |
| Comparative | — | 33 | 230 | 30 | 170 | 88.5 | 90 | No | C | C | A |
| Example 2 | | | | | | | | repairing | | | |

As shown in the table, In each Example, a laminated film having high adhesion between the transparent support substrate and the surface resin layer and excellent visibility is obtained, as compared with Comparative Example 2 in which the ratio [F_{I}/F_{S}×100 (%)] of the fluorine atom content [F_{I}] on the surface of the surface layer after etching the range of 2 mm square on the outermost surface with an argon gas cluster ion gun of 5 kV for 20 minutes to the fluorine atom content [F_{S}] on the outermost surface of the surface layer is more than 50%.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A laminated member comprising:
a transparent support substrate containing a resin, and
a surface resin layer on the transparent support substrate,
wherein the surface resin layer contains a cured product of a resin composition containing:
an acrylic resin having a hydroxyl value of 40 mgKOH/g to 280 mgKOH/g,
a polyol having a plurality of hydroxy groups and having a carbon chain having 6 or more carbon atoms in a straight chain linking the hydroxy groups, and
a polyfunctional isocyanate,
wherein a ratio [(F_{I}/F_{S})×100 (%)] of a fluorine atom content [F_{I}] on a surface of the surface resin layer after etching a range of 2 mm square on an outermost surface of the surface resin layer with an argon gas cluster ion gun of 5 kV for 20 minutes to a fluorine atom content [F_{S}] on the outermost surface of the surface resin layer ranges from 2% to 50%.

2. The laminated member according to claim 1,
wherein the ratio [(F_{I}/F_{S})×100 (%)] ranges from 10% to 40%.

3. The laminated member according to claim 1,
wherein a ratio [(F_{B}/F_{S})×100 (%)] of a fluorine atom content [F_{B}] on an interface of the surface resin layer with the transparent support substrate to the fluorine atom content [F_{S}] on the outermost surface of the surface resin layer ranges from 1% to 40%.

4. The laminated member according to claim 1,
wherein a molar ratio [OH_{A}/OH_{P}] of a total hydroxy group amount [OH_{A}] in the acrylic resin contained in the resin composition to a total hydroxy group amount [OH_{P}] in the polyol contained in the resin composition ranges from 0.1 to 4.

5. The laminated member according to claim 1,
wherein an average thickness of the surface resin layer ranges from 10 μm to 100 μm.

6. The laminated member according to claim 1,
wherein a Martens hardness of the surface resin layer at 23° C. ranges from 0.5 N/mm² to 220 N/mm² and a return rate of the surface resin layer at 23° C. ranges from 70% to 100%.

7. The laminated member according to claim 1,
wherein the transparent support substrate contains a resin selected from the group consisting of a polyester resin, a polycarbonate resin, and a polyacrylate resin.

8. The laminated member according to claim 1,
wherein a surface roughness Ra of an interface of the transparent support substrate with the surface resin layer ranges from 5 nm to 100 nm.

9. The laminated member according to claim 8,
wherein the surface roughness Ra ranges from 10 nm to 50 nm.

10. The laminated member according to claim 1 further comprising,
an adhesive layer containing an adhesive on a surface of the transparent support substrate, the surface not having the surface resin layer.

11. The laminated member according to claim 1,
wherein a 60° glossiness is 130 or more in a surface of the laminated member, the surface having the transparent support substrate.

12. The laminated member according to claim 1,
wherein a ratio of a thickness of the transparent support substrate to a thickness of the surface resin layer ranges from 100:1 to 7:1.

13. The laminated member according to claim 1,
wherein a ratio of a thickness of the transparent support substrate to a thickness of the surface resin layer ranges from 10:1 to 7:1.
